(19) United States
(12) Patent Application Publication
(10) Pub. No.: US 2023/0076616 A1
(43) Pub. Date: Mar. 9, 2023

(54) Software Service For Processing Time Data

(71) Applicant: SAP SE, Walldorf (DE)

(72) Inventors: Brenda Dinger, Portland, OR (US); Rakesh Vijay Jaywant, Mumbai (IN); Hood Munaim, Naperville, IL (US); Mahesh Kumar Rajashekar, Bangalore (IN); Anaranya Sen, Bangalore (IN); Padmanabhan L, Bangalore (IN); Sydney Monis, Mumbai (IN)

(21) Appl. No.: 17/469,666

(22) Filed: Sep. 8, 2021

(51) Int. Cl. G06Q 10/10

(52) U.S. Cl. CPC G06Q 10/1091

(57) ABSTRACT

Some embodiments provide a non-transitory machine-readable medium that stores a program. The program receives a set of raw time data. Each raw time data in the set of raw time data includes an entity identifier (ID), a timestamp, and an event type. The program further generates a set of time events based on the set of raw time data and a time template. The program also generates a set of time records based on the set of time events and the time template. The program further generates a set of time bundles based on the set of time records and the time template.

### BACKGROUND

Time-tracking software allows users (e.g., employees) to record time spent working (e.g., on specific tasks and/or projects). Such software may be used by numerous different types of users such as freelancers, attorneys, accountants, etc. Many types of time-tracking software exist. For example, some time-tracking software are merely digitized versions of timesheets where users can manually enter time spent on different tasks and/or projects. More advanced time-tracking software include additional features like automatic recording of tasks and/or projects as they are being performed, generation of various different reports, integration into other software and/or systems, etc.

Different time-tracking software employ different approaches to track time. For instance, certain time-tracking software have employees enter their own information (e.g., the amounts of time spend on different tasks and/or projects, the start and end times for each task and/or project, etc.). Other time-tracking software use a more automated approach. For example, time-tracking software can be utilized in conjunction with other devices or systems that allows users to provide input to start time tracking and to stop time tracking. The time-tracking software automatically calculates time based on the user input. Other systems track users (e.g., via badge swipes) entering and exiting an office or building.

### SUMMARY

In some embodiments, a non-transitory machine-readable medium stores a program executable by at least one processing unit of a device. The program receives a set of raw time data. Each raw time data in the set of raw time data includes an entity identifier (ID), a timestamp, and an event type. The program further generates a set of time events based on the set of raw time data and a time template. The program also generates a set of time records based on the set of time events and the time template. The program further generates a set of time bundles based on the set of time records and the time template.

In some embodiments, the time template may include a first set of rules configured to process raw time data, a second set of rules configured to process time events, and a third set of rules configured to process time records. Generating the set of time events based on the set of raw time data may include applying the first set of rules to the set of time events. Generating the set of time records based on the set of time events may include applying the second set of rules to the set of time events. Generating the set of time bundles based on the set of time records may include applying the third set of rules to the set of time records.

In some embodiments, each time event in the set of time events may include a timestamp from a raw time data in the set of raw time data and an event type from a raw time data in the set of raw time data. The set of raw data may be received from a time logging system.

In some embodiments, a method receives a set of raw time data. Each raw time data in the set of raw time data includes an entity identifier (ID), a timestamp, and an event type. The method further generates a set of time events based on the set of raw time data and a time template. The method also generates a set of time records based on the set of time events and the time template. The method further generates a set of time bundles based on the set of time records and the time template.

In some embodiments, the time template may include a first set of rules configured to process raw time data, a second set of rules configured to process time events, and a third set of rules configured to process time records. Generating the set of time events based on the set of raw time data may include applying the first set of rules to the set of time events. Generating the set of time records based on the set of time events may include applying the second set of rules to the set of time events. Generating the set of time bundles based on the set of time records may include applying the third set of rules to the set of time records.

In some embodiments, each time event in the set of time events may include a timestamp from a raw time data in the set of raw time data and an event type from a raw time data in the set of raw time data. The set of raw data may be received from a time logging system.

In some embodiments, a system includes a set of processing units and a non-transitory machine-readable medium that stores instructions. The instructions cause at least one processing unit to receive a set of raw time data. Each raw time data in the set of raw time data includes an entity identifier (ID), a timestamp, and an event type. The instructions further cause the at least one processing unit to generate a set of time events based on the set of raw time data and a time template. The instructions also cause the at least one processing unit to generate a set of time records based on the set of time events and the time template. The instructions further cause the at least one processing unit to generate a set of time bundles based on the set of time records and the time template.

In some embodiments, the time template may include a first set of rules configured to process raw time data, a second set of rules configured to process time events, and a third set of rules configured to process time records. Generating the set of time events based on the set of raw time data may include applying the first set of rules to the set of time events. Generating the set of time records based on the set of time events may include applying the second set of rules to the set of time events. Generating the set of time bundles based on the set of time records may include applying the third set of rules to the set of time records. Each time event in the set of time events may include a timestamp from a raw time data in the set of raw time data and an event type from a raw time data in the set of raw time data.

The following detailed description and accompanying drawings provide a better understanding of the nature and advantages of various embodiments of the present disclosure.

### BRIEF DESCRIPTION OF THE DRAWINGS

FIG. 1 illustrates a system for processing time data according to some embodiments.

FIG. 2 illustrates example event type definitions according to some embodiments.

FIG. 3 illustrates example time attribute definitions according to some embodiments.

FIG. 4 illustrates example rule definitions according to some embodiments.

FIG. 5 illustrates example time template definitions according to some embodiments.

FIG. 6 illustrates an architecture of a time processing manager according to some embodiments.

FIG. 7 an example data flow through the system illustrated in FIG. 1 according to some embodiments.

FIG. 8 illustrates a process for configuring a time processing service according to some embodiments.

FIG. 9 illustrates a process for processing time data according to some embodiments.

FIG. 10 illustrates an exemplary computer system, in which various embodiments may be implemented.

FIG. 11 illustrates an exemplary computing device, in which various embodiments may be implemented.

FIG. 12 illustrates an exemplary system, in which various embodiments may be implemented.

### DETAILED DESCRIPTION

In the following description, for purposes of explanation, numerous examples and specific details are set forth in order to provide a thorough understanding of the present disclosure. It will be evident, however, to one skilled in the art that various embodiment of the present disclosure as defined by the claims may include some or all of the features in these examples alone or in combination with other features described below, and may further include modifications and equivalents of the features and concepts described herein.

Described herein are techniques for configuring and using a software service to process time data. In some embodiments, a time processing system may receive several different configurations for the software service. For example, the time processing system can receive a set of time event type definitions that specify different types of time events that the time processing system can process. The time processing system may also receive a set of time attribute definitions that specify attributes that will be used to process time data. Additionally, the time processing system can receive a set of rule definitions that include instructions for how to process time data. The time processing may receive a set of time template definitions. Each time template definition specifies one or more of the defined time event types that the time template can handle, one or more of the defined time attributes to use to process time data, and one or more of the defined rules to use to process time data. When the time processing system receives raw time event data, the time processing system determines a time template to use to process the raw time event data. The time processing system uses the time event types, attributes, and rules specified in the time template to process the raw time event data. For example, based on the time template, the time processing system can generate time event entries from the raw time event data. From the time event entries, the time processing system may generate time record entries. Finally, the time processing can generate time bundle entries based on the time record entries.

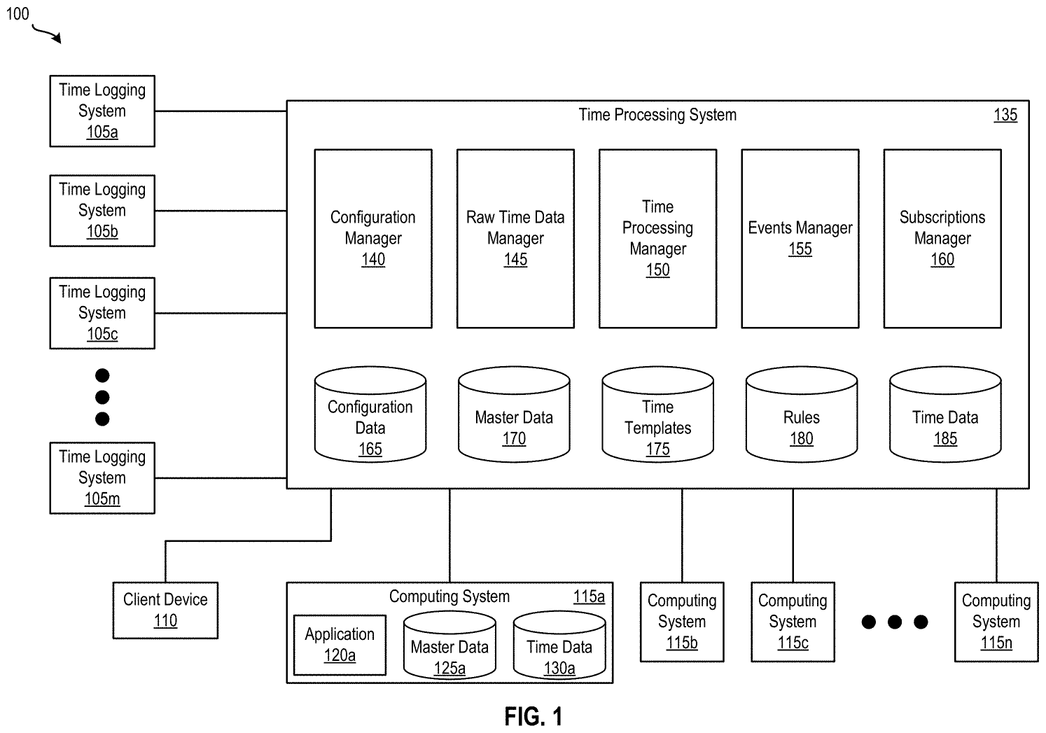

FIG. 1 illustrates a system 100 for processing time data according to some embodiments. As shown, system 100 includes time logging systems 105a-m, client device 110, computing systems 115a-n, and time processing system 135. Each of the time logging systems 105a-m is configured to collect and log time event data (also referred to as raw time event data) in real-time. For example, a time logging system 105 may include a terminal that is part of an access control system where users swipe badges when entering and exiting a building. In some embodiments, each of the time logging systems 105a-m provides collected and logged time event data to time processing system 135 in batches at defined intervals (e.g., once an hour, once every six hours, once a day, etc.). In other embodiments, each of the time logging systems 105a-m provides collected and logged time event data to time processing system 135 in real-time.

Client device 110 may communicate and interact with time processing system 135. For instance, a user of client device 110 can provide configuration information to time processing system 135 (e.g., via a graphical user interface (GUI) provided by time processing system 135). In some instances, a user of client device 110 provides time event data (e.g., raw time event data) to time processing system 135 (e.g., via an application operating on client device 110 or a GUI provided by time processing system 135). While FIG. 1 shows one client device, one of ordinary skill in the art will appreciate that system 100 can include any number of additional client devices that are configured the same as or similar to client device 110.

Each of the computing systems 115a-n is configured to utilize time processing services provided by time processing system 135. As shown in FIG. 1, computing system 115a includes application 120a, master data storage 125a, and time data storage 130a. Each of the computing systems 115b-n may include the same or similar components as computing system 115a. Master data storage 125a stores master data managed by computing system 115a. Examples of master data include data associated with individuals and/or organizations (e.g., employees, customers, buyers, suppliers, etc.), data associated with products, data associated with finances (e.g., ledgers, cost centers, etc.), etc. Computing system 115a may provide master data to time processing system 135 so time processing system 135 can process time data. Time data storage 130a is configured to store time data. Application 120a is a software application operating on computing system 115a that may use time data received from time processing system 135. For instance, application 120a can use the time data in its current form, which has been processed by time processing system 135, further process the time data, store the time data in time data storage 130a, provide the time data to other computing devices/systems or users thereof, etc.

As illustrated in FIG. 1, time processing system 135 includes configuration manager 140, raw time data manager 145, time processing manager 150, events manager 155, subscriptions manager 160, and storages 165-185. Configuration data storage 165 stores configuration information for processing time data. Master data storage 170 is configured to store master data received from computing systems 115a-n. Time templates storage 175 stores time template definitions that are used to process time data. Rules storage 180 is configured to store rules specifying how to process different types of time data. Time data storage 185 stores different types of time data. Examples of types of time data include raw time event data (e.g., time data received from time logging systems 105a-m), time events, time records, and time bundles. In some embodiments, a time event represents a point in time, a time record represents a period of time defined by a pair of time events, and a time bundle represents a collection of time records. In some embodiments, storages 165-185 are implemented in a single physical storage while, in other embodiments, storages 165-185 may be implemented across several physical storages. While FIG. 1 shows storages 165-185 as part of time processing system 135, one of ordinary skill in the art will appreciate that configuration data storage 165, master data storage 170, time templates storage 175, rules storage 180, and/or time data storage 185 may be external to time processing system 135 in some embodiments.

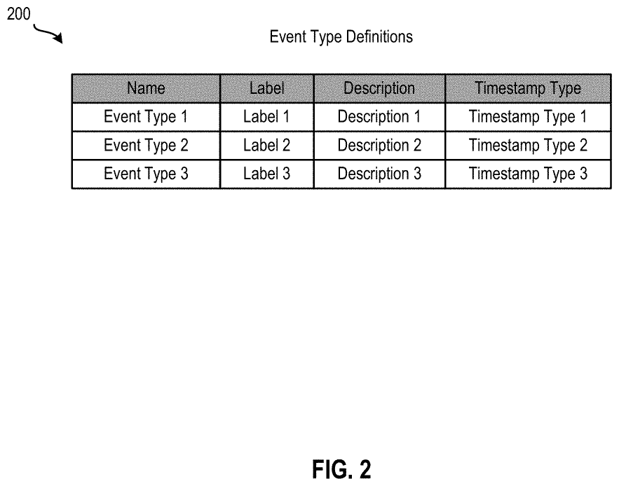

Configuration manager 140 manages information for configuring the processing of time data. For example, configuration manager 140 can receive configuration information from client device 110 through a GUI that time processing system 135 provides to client device 110. In some cases, client device 110 sends the configuration information in the form of a set of configuration files. Several examples of such configuration information will be described by reference to FIGS. 2-5. One type of configuration information that configuration manager 140 receives from client device 110 is event type definitions. In some embodiments, an event type definition specifies a type of time event that time processing system 135 can process (e.g., time events that time processing system 135 can accept from time logging systems 105a-m). FIG. 2 illustrates example event type definitions 200 according to some embodiments. As shown, each of the event type definitions 200 includes a name, a label, a description, and a timestamp type. The name of an event type definition is used to uniquely identify the event type definition. The label of an event type definition specifies how the event type definition may be presented to users. The description of an event type definition provides a description of the type of time event. The timestamp type of an event type definition specifies a type of timestamp. Examples of timestamp types include a start timestamp indicating the start of a time period, a stop timestamp indicating the end of a time period, a stop start timestamp indicating the end of a time period and the start of another time period, etc. In this example, event type definition 200 includes definitions for three different types of time events.

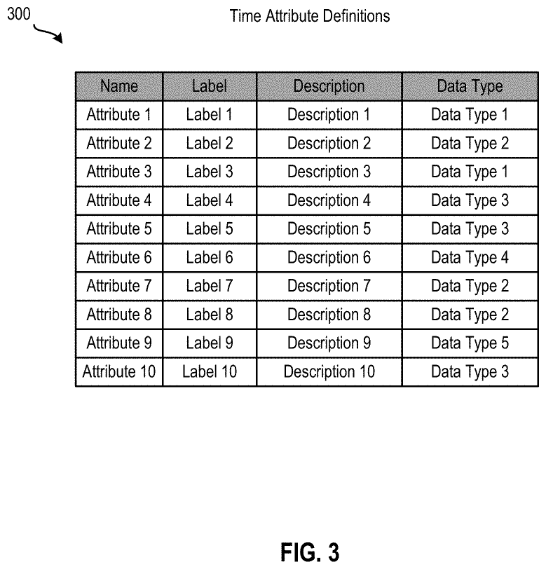

Another type of configuration information that configuration manager 140 may receive from client device 110 is time attribute definitions. In some embodiments, a time attribute definition specifies an attribute that can be used to process time data. In some instances, the attribute is master data from a computing system 115. In other instances, the attribute is data provided from a user of client device 110. FIG. 3 illustrates example time attribute definitions 300 according to some embodiments. As illustrated, each of the time attribute definitions 300 includes a name, a label, a description, and a data type. The name of a time attribute definition is used to uniquely identify the time attribute definition. The label of a time attribute definition specifies how the time attribute definition may be presented to users. The description of a time attribute definition provides a description of the time attribute. The data type of a time attribute definition specifies the type of data that the time attribute can have. Examples of data types include text, numbers, expressions, picklists, etc. In some embodiments, a picklist is a defined list of possible values from a particular data source. For this example, time attribute definitions 300 include definitions for ten different time attributes.

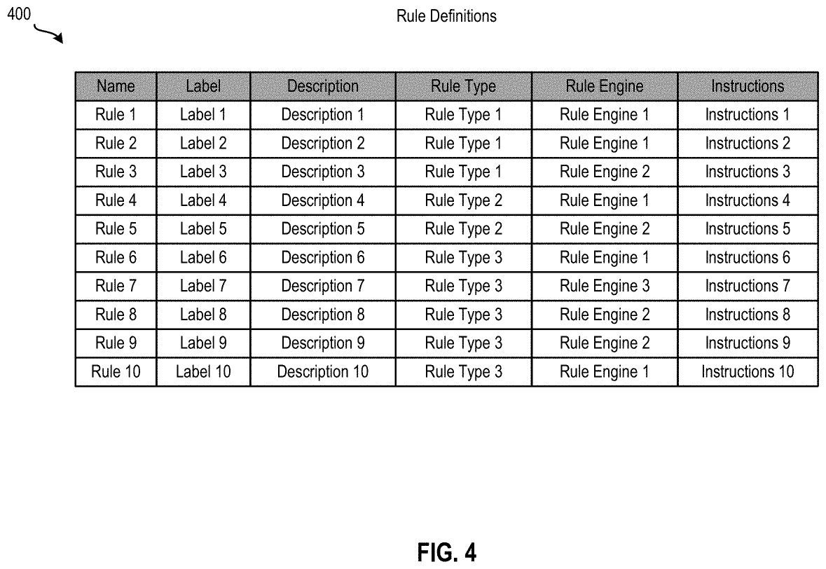

Configuration manager 140 can receive rule definitions from client device 110. In some embodiments, a rule definition specifies how to process time data. FIG. 4 illustrates example rule definitions 400 according to some embodiments. As shown, rule definitions 400 each of the time attribute definitions 400 includes a name, a label, a description, a rule type, a rule engine, and a set of instructions. The name of a rule definition is used to uniquely identify the rule definition. The label of a rule definition specifies how the rule definition may be presented to users. The description of a rule definition provides a description of the rule. The rule type of a rule definition specifies a type of rule. Different types of rules can be used to process different types of time data. Examples of types of rules include raw time event rules for processing raw time event data, time event rules for processing time event entries, time record rules for processing time record entries, etc. The rule engine of a rule definition specifies a rule engine to use to process the rule. The set of instructions of a rule definition specify how to process time data. In this example, rule definitions 400 include definitions for ten different rules.

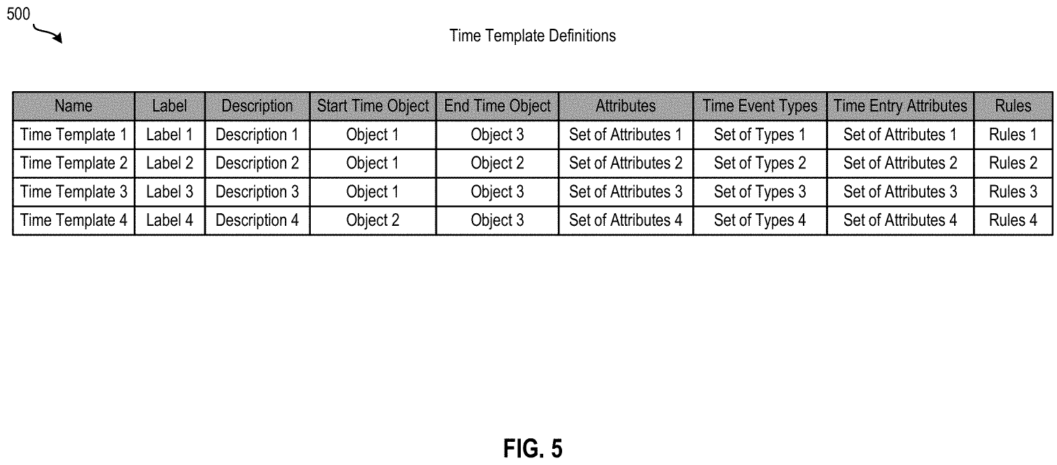

Another example type of configuration information that configuration manager 140 may receive from client device 110 is time template definitions. In some embodiments, time templates provide the mechanism through which different time data is processed. FIG. 5 illustrates example time template definitions 500 according to some embodiments. As illustrated, each of the time template definitions 500 includes a name, a label, a description, a start time object, an end time object, a set of attributes, a set of time event types, a set of time entry attributes, and a set of rules. The name of a time template definition is used to uniquely identify the time template. The label of a time template definition specifies how the time template definition may be presented to users. The description of a time template definition provides a description of the time template. The start time object of a time template definition specifies the type of object (e.g., raw time event data, time event entries, time record entries, etc.) that the time template takes as input. The end time object of a time template definition specifies the type of object (e.g., time event entries, time record entries, time bundle entries, etc.) that the time template generates as output. The set of attributes of a time template definition specifies one or more attributes that the time template uses to process time data (e.g., attributes used by rules specified in the time template). The attributes are defined by time attribute definitions (e.g., time attribute definitions 300) that configuration manager 120 receives. The set of time event types of a time template definition specifies one or more types of time events that the time template can process. The event types are defined by event type definitions (e.g., event type definitions 200) that configuration manager 140 receives. The time entry attributes of a time template definition specifies different sets of attributes to use to generate different time entries. For example, time entry attributes may specify a first set of attributes to be included in time event entries when time event entries are generated, a second set of attributes to be included in time record entries when time event record are generated, and a third set of attributes to be included in time bundle entries when time bundle entries are generated. In some embodiments, these different sets of attributes are subsets of the set of attributes defined for the time template. The rules of a time template specify a set of rules to use to process different types of time data. For instance, a time template specify a first set of rules to process raw time event data into time event entries, a second set of rules to process time event entries into time record entries, and a third set of rules to process time record entries into time bundle entries. The rules are defined by rule definitions (e.g., rule definitions 400) that configuration manager 140 receives.

The example configuration information described above are example of some of the types of configuration information that configuration manager 140 receives from client device 110. One of ordinary skill in the art will understand that client device 110 may provide configuration manager 140 with additional and/or different information for configuring additional and/or different features for processing time data. For example, configuration manager 140 can receive master data definitions that specify the source of master data (e.g., a computing system 115) and the attributes in the master data, connection definitions specifying information for connecting to different computing systems (e.g., servers), picklist definitions specifying a data source and a set of values from the data source, etc. Details of how configuration information is used to process time data will be described below.

Returning to FIG. 1, raw time data manager 145 is configured to manage raw time event data. For instance, when time processing system 135 receives raw time event data from a time logging system 105, raw time data manager 145 stores it in time data storage 185 (or another storage configured to store raw time event data). In some embodiments, at defined intervals (e.g., once an hour, once every four hours, once a day, etc.), raw time data manager 145 retrieves a batch of unprocessed raw time event data from time data storage 185 and sends it to time processing manager 150 for processing.

Time processing manager 150 is configured to process raw time event data to generate different types of time data. For example, upon receiving a batch of raw time event data from raw time data manager 145, time processing manager 150 can determine a set of time templates (e.g., one or more time templates defined by time template definitions 500) to use to process the batch of raw time event data. Time processing manager 150 may generate time event entries based on the set of time templates and the batch of raw time event data. Based on the time event entries and the set of time templates, time processing manager 150 can generate time record entries. Also, time processing manager 150 may generate time bundle entries based on the time record entries and the set of time templates. When time processing manager 150 generates time data, time processing manager 150 sends events manager 155 a notification indicating so. Time processing manager 150 stores time data that it generates in time data storage 185.

Events manager 155 serves as a communication bus for events. For instance, events manager 155 can provide an interface through which components (e.g., subscriptions manager 160) can listen for events. Through the interface, any notifications of events occurring (e.g., a time event entry was generated, a time record entry was generated, a time bundle entry was generated, etc.) that events manager 155 receives from time processing manager 150 is communicated to listening components.

Subscriptions manager 160 is configured to manage subscriptions for time data. For example, subscription manager 160 may listen for events via an interface provided by events manager 155. When subscription manager 160 receives a notification of a particular event occurring, subscription manager 160 determines whether any subscribers (e.g., a computing system 115) to the particular event exist based on subscription definitions (e.g., stored in configuration data storage 165). If any exist, then subscription manager 160 sends information associated with the event to the subscribers based on information in the subscription definitions.

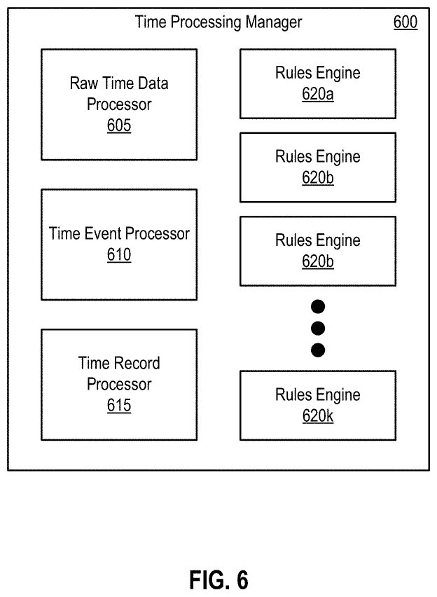

FIG. 6 illustrates an architecture of a time processing manager 600 according to some embodiments. In some embodiments, time processing manager 600 is used to implement time processing manager 150. As illustrated, time processing manager 600 includes raw time data processor 605, time event processor 610, time record processor 615, and rules engines 620a-k. Each of the rules engines 620a-k are configured to apply rules to time data. Different rules engines and/or types of rules engines may be used to implement a rule engine 620. Examples of such rules engines and/or types of rules engines include a Groovy-based rules engine, a business rules engine, a production/inference rules-based engine, a reaction/event condition action rules-based engine, etc.

Raw time data processor 605 handles the processing of raw time event data. For instance, time processing manager 600 can receive a batch of raw time event data (e.g., from raw time data manager 145). To process a piece of raw time event data, raw time data processor 605 determines a time template (e.g., a time template stored in time templates storage 175) to use to process the piece of raw time event data. The time template may specify a rule to use to process raw time event data and a rules engine 620 to use. Raw time data processor 605 uses the specified rules engine 620 to apply the specified rule to the piece of raw time event data to generate a time event entry. Raw time data processor 605 stores the time event entry (e.g., in time data storage 185). Then, raw time data processor 605 sends the generated time event entry to time event processor 610 for further processing. Raw time data processor 605 can send a notification to events manager 155 indicating that a time event entry has been created.

Time event processor 610 is configured to process time event entries. For example, time event processor 610 may receive a time event entry from raw time data processor 605. In response, time event processor 610 determines a time template (e.g., a time template stored in time templates storage 175) to use to process the time event entry. The determined time template can specify a rule to use to process time event entries and a rules engine 620 to use. Next, time event processor 610 uses the specified rules engine 620 to apply the specified rule to the time event entry to generate a time record entry, which time event processor 610 stores (e.g., in time data storage 185). Time event processor 610 then sends the generated time record entry to time record processor 615 for further processing. Time record processor 615 may send events manager 155 a notification indicating that a time record entry has been created.

Time record processor 615 is responsible for processing time record entries. For instance, when time record processor 615 receives a time record entry from time event processor 610, time record processor 615 determines a time template (e.g., a time template stored in time templates storage 175) to use to process the time record entry. The time template may specify a rule to use to process time event entries and a rules engine 620 to use. Time record processor 615 uses the specified rules engine 620 to apply the specified rule to the time record entry to generate a time bundle entry. Next, time record processor 615 sends stores the generated time bundle entry (e.g., in time data storage 185). Time record processor 615 can send a notification to events manager 155 indicating that a time bundle entry has been created.

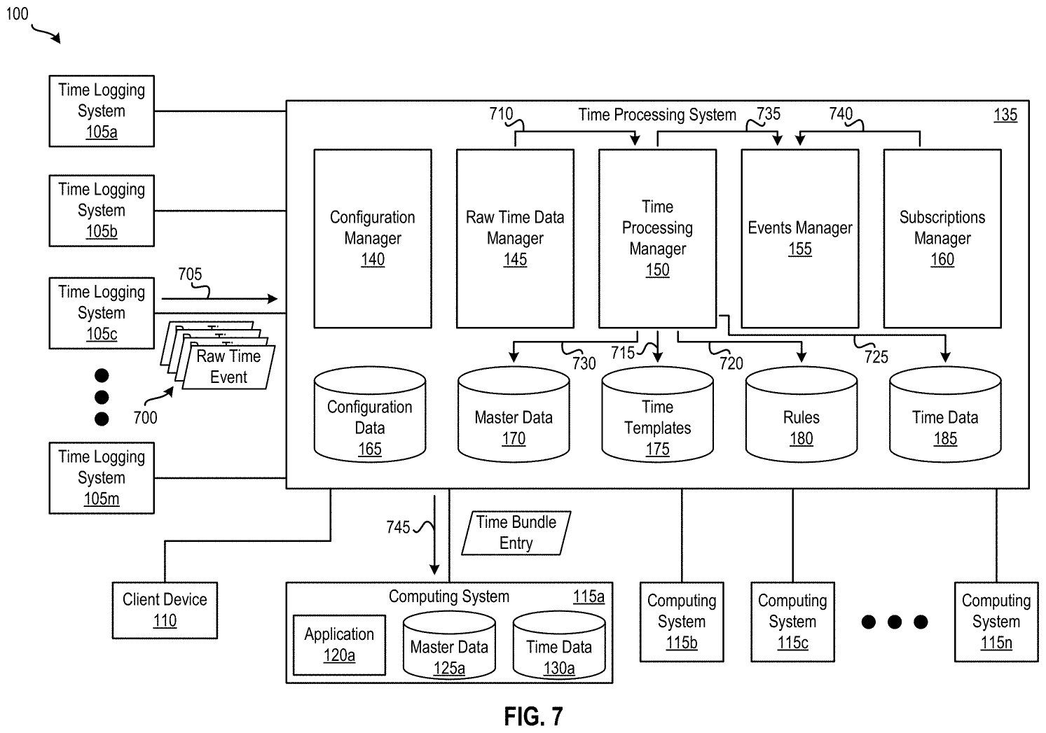

An example operation of system 100 will now be described by reference to FIGS. 2-7. The example operation describes how time processing system 135 processes time data based on the example configuration information illustrated in FIGS. 2-5. FIG. 7 illustrates an example data flow through system 100 according to some embodiments. Specifically, FIG. 7 illustrates the data flow through system 100 for this example operation. In addition, time processing manager 600 is used to implement time processing manager 150 in this example.

The operation starts by raw time data manager 145 receiving, at 705, raw time event data 700 from time logging system 105c. In this example, each piece of raw time event data includes an entity identifier (ID) associated with a person (e.g., an employee), a timestamp of when time logging system 105c detected activity associated with the person (e.g., the person swiped a badge at a terminal), and an event type (e.g., a start time event, a stop time event, a stop and start time event, etc.). For this example, the entity ID in each piece of the raw time event data 700 is an ID managed by time logging system 105c (also referred to as an external entity ID). After receiving raw time event data 700, raw time data manager 145 stores them in time data storage 185.

At a defined interval, raw time data manager 145 retrieves a batch of raw event time data from time data storage 185 and sends, at 710, it to time processing manager 150 for processing. Once time processing manager 150 receives the batch of raw time event data, time processing manager 150 processes it. For this example, the activities of the persons that time logging system 105c collected and logged are represented as person entities in master data stored in master data storage 125a of computing system 115a. Here, the configuration information stored in configuration data storage 165 includes mappings between the external entity ID of a particular person and the ID associated with a person entity in the master data (also referred to as an internal person ID) that represents the same particular person. For this example, each person entity the master data also specifies a time template defined by a particular time template definition in time template definitions 500.

Raw time data processor 605 processes a piece of raw time event data by determining the ID associated with an person entity based on the external entity ID of the piece of raw time event data and the mappings stored in configuration data storage 165. Then, raw time data processor 605 accesses, at 715, time templates storage 175 to retrieve the time template specified in the person entity. Next, raw time data processor 605 accesses, at 720, rules storage 180 to retrieve a raw time event rule specified in the time template. Using the set of instructions and the rule engine 620 specified in the rule definition of the raw time event rule, raw time data processor 605 processes the piece of raw time event data to generate a time event entry. Here, the time event entry includes the internal person ID as well as the timestamp and the event type from the piece of raw time event data. Raw time data processor 605 stores the time event entry in time data storage 185 and sends, at 735, a notification to events manager 155 indicating that a time event entry has been created. After raw time data processor 605 processes the batch of raw time event data, raw time data processor 605 sends the generated time event entries to time event processor 610.

To process a received time event entry, time event processor 610 determines the person entity in master data storage 170 associated with the internal person ID specified in the time event entry. Next, time event processor 610 accesses time templates storage 175 to retrieve the time template specified in the person entity. Time event processor 610 accesses rules storage 180 to retrieve a time event rule specified in the time template. Based on the set of instructions and the rule engine 620 specified in the rule definition of the time event rule, time event processor 610 processes the time event entry to generate a time record entry. For example, if the time event entry is a stop time event, the time event rule may try to identify a time event entry associated with the person entity that is a start time event. If one exists, the time event rule generates a time record entry based on these two time event entries. Time record entry in this example can include the internal person ID, the timestamp of the start time event entry as the start time, the timestamp of the stop time event entry as the end time, and a number calculated hours within the period defined by the start time and the end time. The time record entry may include other attributes (e.g., master data attributes) as defined by the time entry attributes portion of the time template definition. If any attributes are master data attributes, time event processor 610 accesses, at 730, master data storage 170 to retrieve the specified attributes. Time event processor 610 stores the time record entry in time data storage 185 and sends events manager 155 a notification indicating that a time record entry has been created. Once time event processor 610 finishes processes all of the time event entries, time event processor 610 sends the time record entries to time bundle processor 615.

Upon receiving the time record entries from time event processor 610, time record processor 615 processes each of the time record entries. For a particular time record entry, time record processor 615 determines the person entity in master data storage 170 associated with the internal person ID specified in the time record entry. Time record processor 615 then accesses time templates storage 175 to retrieve the time template specified in the person entity. Next, time record processor 615 accesses rules storage 180 to retrieve a time record rule specified in the time template. Based on the set of instructions and the rule engine 620 specified in the rule definition of the time record rule, time record processor 615 processes the time record entry to generate a time bundle entry. For instance, the time record rule may try to identify time record entries associated with the person entity that have time periods on the same day. The time record rule generates a time bundle entry that is a collection of time record entries that includes the identified time record entries. Based on the total time in the collection of time record entries and the instructions in the time record rule, the time record rule can allocate rate categories to different portions of the total time. For example, if the total time is 12 hours, the time record rule may allocate 8 hours to a standard time rate category and 4 hours to an overtime rate category. In this example, the time bundle entry includes the internal person ID, the total time, and time amounts allocated for different rate categories. The time bundle entry can include other attributes (e.g., master data attributes) as defined by the time entry attributes portion of the time template definition. If any attributes are master data attributes, time record processor 615 accesses master data storage 170 to retrieve the specified attributes. Then, time record processor 615 stores the time bundle entry in time data storage 185 and sends events manager 155 a notification indicating that a time bundle entry has been created.

For this example, a subscription definition in configuration data storage 165 specifies that time bundle entries are to be sent to computing system 115a when one is created. As such, when events manager 155 receives a notification from time processing manager 150 that a time bundle entry has been created, subscriptions manager 160 detects, at 740, it. In response, subscription manager 160 determines that computing system 115a is a subscriber of such an event based on the subscription definition and then sends, at 745, the time bundle entry to computing system 115a, as depicted in FIG. 7.

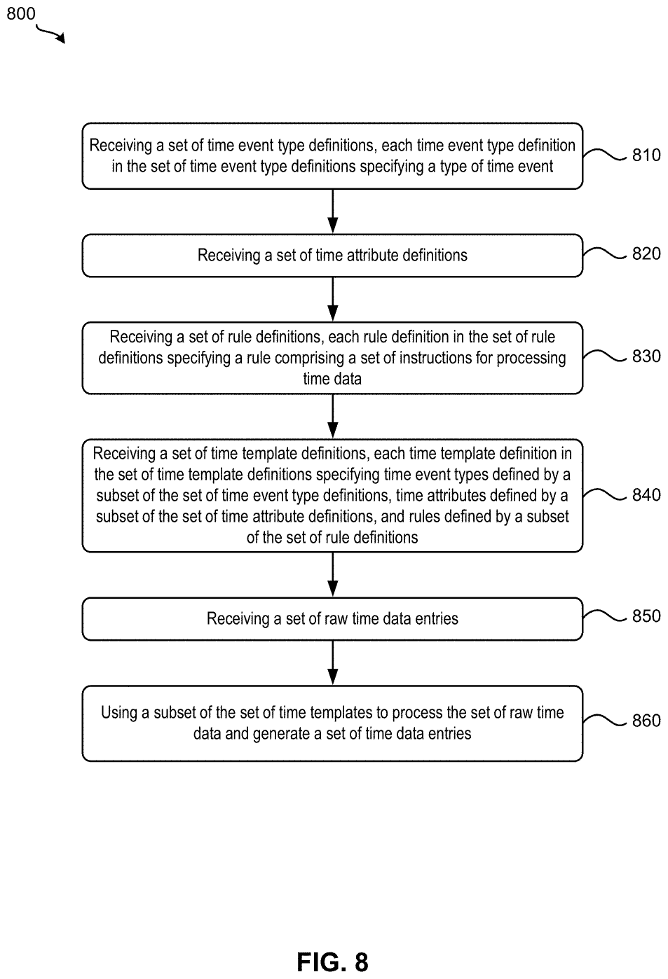

FIG. 8 illustrates a process 800 for configuring a time processing service according to some embodiments. In some embodiments, time processing system 135 performs process 800. Process 800 begins by receiving, at 810, a set of time event type definitions. Each time event type definition in the set of time event type definitions specifies a type of time event. Referring to FIGS. 1 and 2 as an example, configuration manager 140 may receive event type definitions 200 from client device 110.

Next, process 800 receives, at 820, a set of time attribute definitions. Referring to FIGS. 1 and 2 as an example, configuration manager 140 can receive time attribute definitions 300 from client device 110. Process 600 then receives, at 830, a set of rule definitions. Each rule definition in the set of rule definitions specifies a rule comprising a set of instructions for processing time data. Referring to FIGS. 1 and 2 as an example, configuration manager 140 may receive rule definitions 400 from client device 110.

At 840, process 800 receives a set of time template definitions. Each time template definition in the set of time template definitions specifies time event types defined by a subset of the set of time event type definitions, time attributes defined by a subset of the set of time attribute definitions, and rules defined by a subset of the set of rule definitions. Referring to FIGS. 1 and 2 as an example, configuration manager 140 can receive time template definitions 500 from client device 110.

Next, process 800 receives, at 850, a set of raw time data entries. Referring to FIG. 7 as an example, raw time data manager 145 may receive raw time event data 700 from time logging system 105c. Finally, process 800 uses, at 860, a subset of the set of time templates to process the set of raw time data and generate a set of time data entries. Referring to FIGS. 6 and 7 as an example, time processing manager 600 processes raw time event data 700 in the manner described above in the example operation.

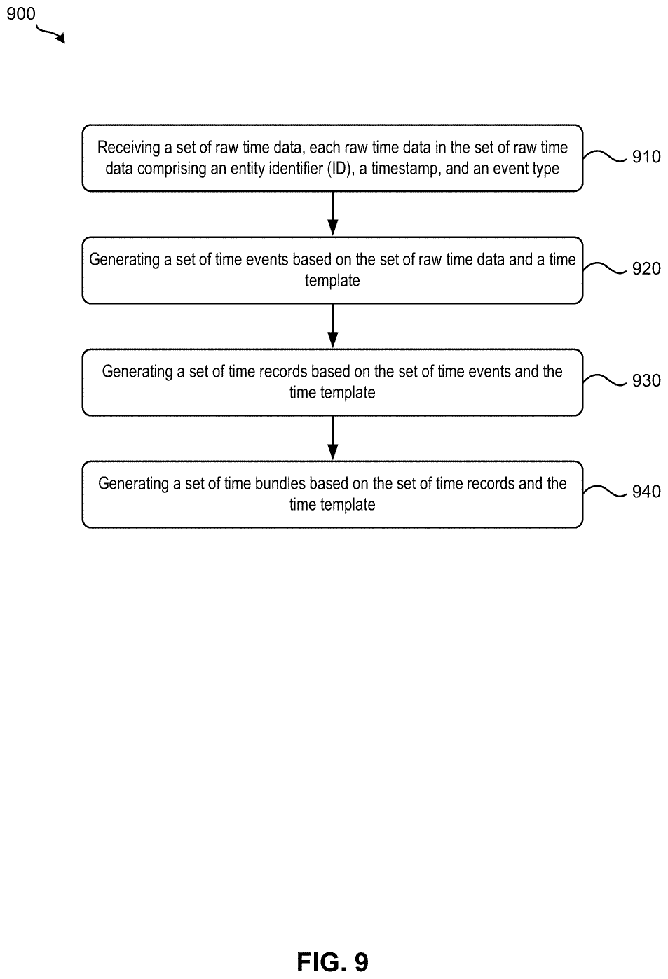

FIG. 9 illustrates a process 900 for processing time data according to some embodiments. In some embodiments, time processing system 135 performs process 900. Process 900 starts by receiving, at 910, a set of raw time data. Each raw time data in the set of raw time data includes an entity identifier (ID), a timestamp, and an event type. Referring to FIG. 7 as an example, raw time data manager 145 may receive raw time event data 700 from time logging system 105c.

Next, process 900 generates, at 920, a set of time events based on the set of raw time data and a time template. Referring to FIGS. 6 and 7 as an example, raw time data processor 605 processes each piece of raw time event data by determining a time template (e.g., a time template stored in time templates storage 175) to use to process the piece of raw time event data. Raw time data processor 605 process the piece of raw time event data based on the time template to generate a time event entry.

Process 900 then generates, at 930, a set of time records based on the set of time events and the time template. Referring to FIGS. 6 and 7 as an example, time event processor 610 may process each time event entry by determining a time template (e.g., a time template stored in time templates storage 175) to use to process the time event entry. Time event processor 610 process the time event entry based on the time template to generate a time record entry.

Finally, process 900 generates, at 940, a set of time bundles based on the set of time records and the time template. Referring to FIGS. 6 and 7 as an example, time record processor 615 can process each time record entry by determining a time template (e.g., a time template stored in time templates storage 175) to use to process the time record entry. Time record processor 615 process the time record entry based on the time template to generate a time bundle entry.

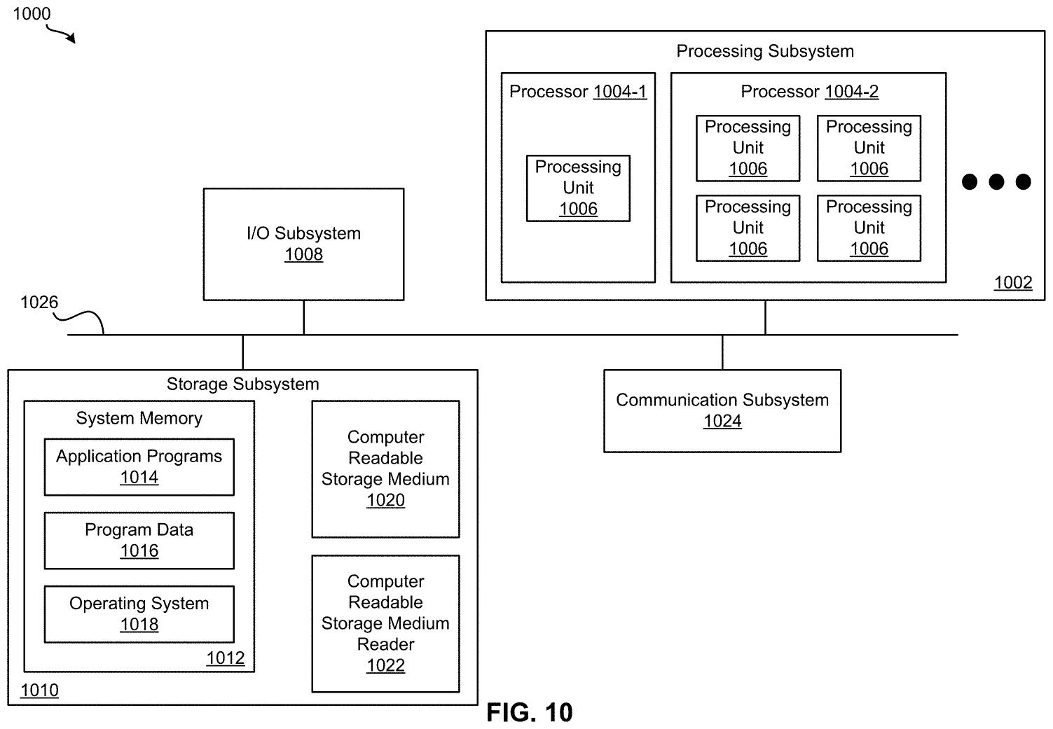

FIG. 10 illustrates an exemplary computer system 1000 for implementing various embodiments described above. For example, computer system 1000 may be used to implement time logging systems 105a-m, client device 110, computing systems 115a-n, and time processing system 135. Computer system 1000 may be a desktop computer, a laptop, a server computer, or any other type of computer system or combination thereof. Some or all elements of application 120a, configuration manager 140, raw time data manager 145, time processing manager 150, events manager 155, subscriptions manager 160, or combinations thereof can be included or implemented in computer system 1000. In addition, computer system 1000 can implement many of the operations, methods, and/or processes described above (e.g., process 800 and process 900). As shown in FIG. 10, computer system 1000 includes processing subsystem 1002, which communicates, via bus subsystem 1026, with input/output (I/O) subsystem 1008, storage subsystem 1010 and communication subsystem 1024.

Bus subsystem 1026 is configured to facilitate communication among the various components and subsystems of computer system 1000. While bus subsystem 1026 is illustrated in FIG. 10 as a single bus, one of ordinary skill in the art will understand that bus subsystem 1026 may be implemented as multiple buses. Bus subsystem 1026 may be any of several types of bus structures (e.g., a memory bus or memory controller, a peripheral bus, a local bus, etc.) using any of a variety of bus architectures. Examples of bus architectures may include an Industry Standard Architecture (ISA) bus, a Micro Channel Architecture (MCA) bus, an Enhanced ISA (EISA) bus, a Video Electronics Standards Association (VESA) local bus, a Peripheral Component Interconnect (PCI) bus, a Universal Serial Bus (USB), etc.

Processing subsystem 1002, which can be implemented as one or more integrated circuits (e.g., a conventional microprocessor or microcontroller), controls the operation of computer system 1000. Processing subsystem 1002 may include one or more processors 1004. Each processor 1004 may include one processing unit 1006 (e.g., a single core processor such as processor 1004-1) or several processing units 1006 (e.g., a multicore processor such as processor 1004-2). In some embodiments, processors 1004 of processing subsystem 1002 may be implemented as independent processors while, in other embodiments, processors 1004 of processing subsystem 1002 may be implemented as multiple processors integrate into a single chip or multiple chips. Still, in some embodiments, processors 1004 of processing subsystem 1002 may be implemented as a combination of independent processors and multiple processors integrated into a single chip or multiple chips.

In some embodiments, processing subsystem 1002 can execute a variety of programs or processes in response to program code and can maintain multiple concurrently executing programs or processes. At any given time, some or all of the program code to be executed can reside in processing subsystem 1002 and/or in storage subsystem 1010. Through suitable programming, processing subsystem 1002 can provide various functionalities, such as the functionalities described above by reference to process 800 and process 900.

I/O subsystem 1008 may include any number of user interface input devices and/or user interface output devices. User interface input devices may include a keyboard, pointing devices (e.g., a mouse, a trackball, etc.), a touchpad, a touch screen incorporated into a display, a scroll wheel, a click wheel, a dial, a button, a switch, a keypad, audio input devices with voice recognition systems, microphones, image/video capture devices (e.g., webcams, image scanners, barcode readers, etc.), motion sensing devices, gesture recognition devices, eye gesture (e.g., blinking) recognition devices, biometric input devices, and/or any other types of input devices.

User interface output devices may include visual output devices (e.g., a display subsystem, indicator lights, etc.), audio output devices (e.g., speakers, headphones, etc.), etc. Examples of a display subsystem may include a cathode ray tube (CRT), a flat-panel device (e.g., a liquid crystal display (LCD), a plasma display, etc.), a projection device, a touch screen, and/or any other types of devices and mechanisms for outputting information from computer system 1000 to a user or another device (e.g., a printer).

As illustrated in FIG. 10, storage subsystem 1010 includes system memory 1012, computer-readable storage medium 1020, and computer-readable storage medium reader 1022. System memory 1012 may be configured to store software in the form of program instructions that are loadable and executable by processing subsystem 1002 as well as data generated during the execution of program instructions. In some embodiments, system memory 1012 may include volatile memory (e.g., random access memory (RAM)) and/or non-volatile memory (e.g., read-only memory (ROM), programmable read-only memory (PROM), erasable programmable read-only memory (EPROM), electrically erasable programmable read-only memory (EEPROM), flash memory, etc.). System memory 1012 may include different types of memory, such as static random access memory (SRAM) and/or dynamic random access memory (DRAM). System memory 1012 may include a basic input/output system (BIOS), in some embodiments, that is configured to store basic routines to facilitate transferring information between elements within computer system 1000 (e.g., during start-up). Such a BIOS may be stored in ROM (e.g., a ROM chip), flash memory, or any other type of memory that may be configured to store the BIOS.

As shown in FIG. 10, system memory 1012 includes application programs 1014 (e.g., application 115), program data 1016, and operating system (OS) 1018. OS 1018 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple iOS, Windows Phone, Windows Mobile, Android, BlackBerry OS, Blackberry 10, and Palm OS, WebOS operating systems.

Computer-readable storage medium 1020 may be a non-transitory computer-readable medium configured to store software (e.g., programs, code modules, data constructs, instructions, etc.). Many of the components (e.g., application 120a, configuration manager 140, raw time data manager 145, time processing manager 150, events manager 155, and subscriptions manager 160) and/or processes (e.g., process 800 and process 900) described above may be implemented as software that when executed by a processor or processing unit (e.g., a processor or processing unit of processing subsystem 1002) performs the operations of such components and/or processes. Storage subsystem 1010 may also store data used for, or generated during, the execution of the software.

Storage subsystem 1010 may also include computer-readable storage medium reader 1022 that is configured to communicate with computer-readable storage medium 1020. Together and, optionally, in combination with system memory 1012, computer-readable storage medium 1020 may comprehensively represent remote, local, fixed, and/or removable storage devices plus storage media for temporarily and/or more permanently containing, storing, transmitting, and retrieving computer-readable information.

Computer-readable storage medium 1020 may be any appropriate media known or used in the art, including storage media such as volatile, non-volatile, removable, non-removable media implemented in any method or technology for storage and/or transmission of information. Examples of such storage media includes RAM, ROM, EEPROM, flash memory or other memory technology, compact disc read-only memory (CD-ROM), digital versatile disk (DVD), Blu-ray Disc (BD), magnetic cassettes, magnetic tape, magnetic disk storage (e.g., hard disk drives), Zip drives, solid-state drives (SSD), flash memory card (e.g., secure digital (SD) cards, CompactFlash cards, etc.), USB flash drives, or any other type of computer-readable storage media or device.

Communication subsystem 1024 serves as an interface for receiving data from, and transmitting data to, other devices, computer systems, and networks. For example, communication subsystem 1024 may allow computer system 1000 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication subsystem 1024 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication subsystem 1024 may provide components configured for wired communication (e.g., Ethernet) in addition to or instead of components configured for wireless communication.

One of ordinary skill in the art will realize that the architecture shown in FIG. 10 is only an example architecture of computer system 1000, and that computer system 1000 may have additional or fewer components than shown, or a different configuration of components. The various components shown in FIG. 10 may be implemented in hardware, software, firmware or any combination thereof, including one or more signal processing and/or application specific integrated circuits.

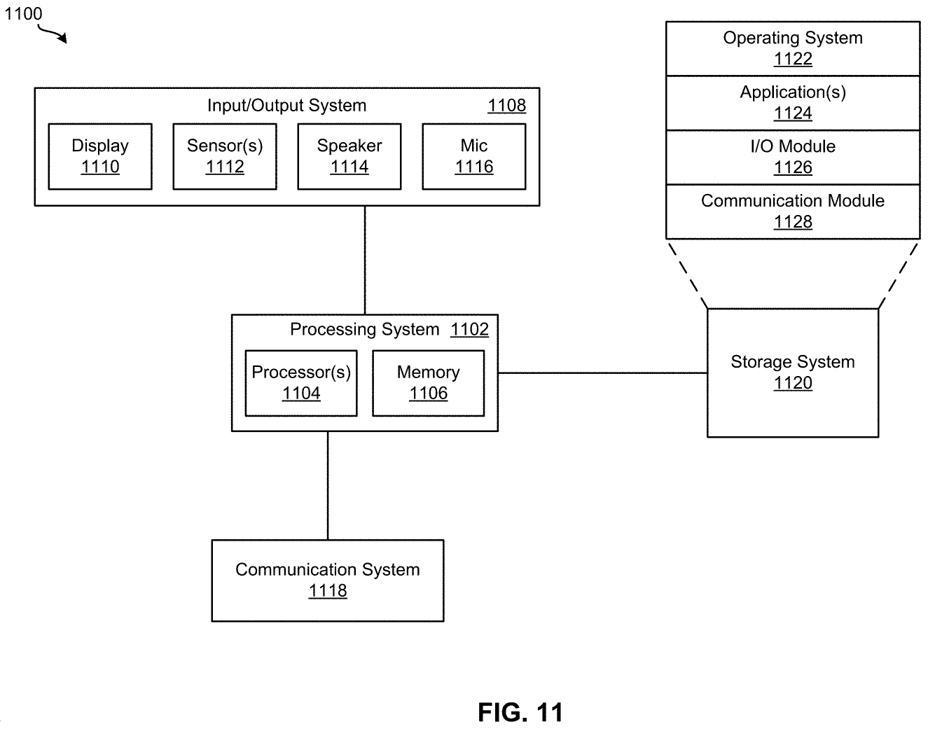

FIG. 11 illustrates an exemplary computing device 1100 for implementing various embodiments described above. For example, computing device 1100 may be used to implement devices client device 110. Computing device 1100 may be a cellphone, a smartphone, a wearable device, an activity tracker or manager, a tablet, a personal digital assistant (PDA), a media player, or any other type of mobile computing device or combination thereof. As shown in FIG. 11, computing device 1100 includes processing system 1102, input/output (I/O) system 1108, communication system 1118, and storage system 1120. These components may be coupled by one or more communication buses or signal lines.

Processing system 1102, which can be implemented as one or more integrated circuits (e.g., a conventional microprocessor or microcontroller), controls the operation of computing device 1100. As shown, processing system 1102 includes one or more processors 1104 and memory 1106. Processors 1104 are configured to run or execute various software and/or sets of instructions stored in memory 1106 to perform various functions for computing device 1100 and to process data.

Each processor of processors 1104 may include one processing unit (e.g., a single core processor) or several processing units (e.g., a multicore processor). In some embodiments, processors 1104 of processing system 1102 may be implemented as independent processors while, in other embodiments, processors 1104 of processing system 1102 may be implemented as multiple processors integrate into a single chip. Still, in some embodiments, processors 1104 of processing system 1102 may be implemented as a combination of independent processors and multiple processors integrated into a single chip.

Memory 1106 may be configured to receive and store software (e.g., operating system 1122, applications 1124, I/O module 1126, communication module 1128, etc. from storage system 1120) in the form of program instructions that are loadable and executable by processors 1104 as well as data generated during the execution of program instructions. In some embodiments, memory 1106 may include volatile memory (e.g., random access memory (RAM)), non-volatile memory (e.g., read-only memory (ROM), programmable read-only memory (PROM), erasable programmable read-only memory (EPROM), electrically erasable programmable read-only memory (EEPROM), flash memory, etc.), or a combination thereof.

I/O system 1108 is responsible for receiving input through various components and providing output through various components. As shown for this example, I/O system 1108 includes display 1110, one or more sensors 1112, speaker 1114, and microphone 1116. Display 1110 is configured to output visual information (e.g., a graphical user interface (GUI) generated and/or rendered by processors 1104). In some embodiments, display 1110 is a touch screen that is configured to also receive touch-based input. Display 1110 may be implemented using liquid crystal display (LCD) technology, light-emitting diode (LED) technology, organic LED (OLED) technology, organic electro luminescence (OEL) technology, or any other type of display technologies. Sensors 1112 may include any number of different types of sensors for measuring a physical quantity (e.g., temperature, force, pressure, acceleration, orientation, light, radiation, etc.). Speaker 1114 is configured to output audio information and microphone 1116 is configured to receive audio input. One of ordinary skill in the art will appreciate that I/O system 1108 may include any number of additional, fewer, and/or different components. For instance, I/O system 1108 may include a keypad or keyboard for receiving input, a port for transmitting data, receiving data and/or power, and/or communicating with another device or component, an image capture component for capturing photos and/or videos, etc.

Communication system 1118 serves as an interface for receiving data from, and transmitting data to, other devices, computer systems, and networks. For example, communication system 1118 may allow computing device 1100 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication system 1118 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication system 1118 may provide components configured for wired communication (e.g., Ethernet) in addition to or instead of components configured for wireless communication.

Storage system 1120 handles the storage and management of data for computing device 1100. Storage system 1120 may be implemented by one or more non-transitory machine-readable mediums that are configured to store software (e.g., programs, code modules, data constructs, instructions, etc.) and store data used for, or generated during, the execution of the software.

In this example, storage system 1120 includes operating system 1122, one or more applications 1124, I/O module 1126, and communication module 1128. Operating system 1122 includes various procedures, sets of instructions, software components and/or drivers for controlling and managing general system tasks (e.g., memory management, storage device control, power management, etc.) and facilitates communication between various hardware and software components. Operating system 1122 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple iOS, Windows Phone, Windows Mobile, Android, BlackBerry OS, Blackberry 10, and Palm OS, WebOS operating systems.

Applications 1124 can include any number of different applications installed on computing device 1100. Examples of such applications may include a browser application, an address book application, a contact list application, an email application, an instant messaging application, a word processing application, JAVA-enabled applications, an encryption application, a digital rights management application, a voice recognition application, location determination application, a mapping application, a music player application, etc.

I/O module 1126 manages information received via input components (e.g., display 1110, sensors 1112, and microphone 1116) and information to be outputted via output components (e.g., display 1110 and speaker 1114). Communication module 1128 facilitates communication with other devices via communication system 1118 and includes various software components for handling data received from communication system 1118.

One of ordinary skill in the art will realize that the architecture shown in FIG. 11 is only an example architecture of computing device 1100, and that computing device 1100 may have additional or fewer components than shown, or a different configuration of components. The various components shown in FIG. 11 may be implemented in hardware, software, firmware or any combination thereof, including one or more signal processing and/or application specific integrated circuits.

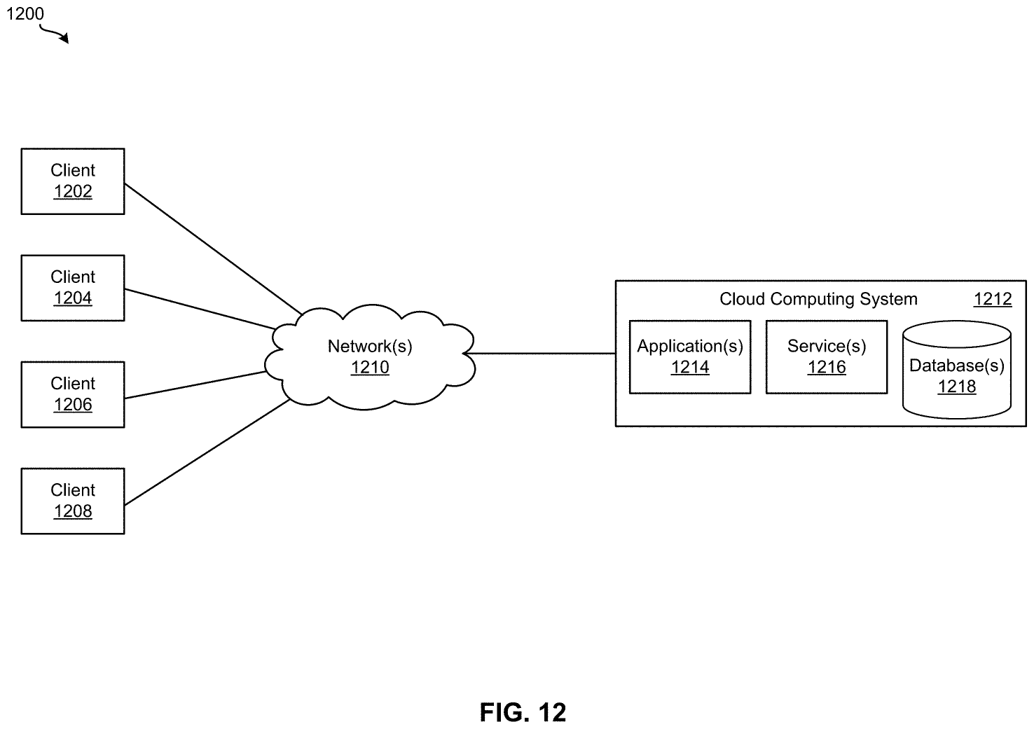

FIG. 12 illustrates an exemplary system 1200 for implementing various embodiments described above. For example, cloud computing system 1212 may be used to implement time logging systems 115a-m, one of the client devices 1202-1208 may be used to implement client device 110, cloud computing system 1212 can be used to implement computing systems 115a-n, and cloud computing system may be used to implement time processing system 135. As shown, system 1200 includes client devices 1202-1208, one or more networks 1210, and cloud computing system 1212. Cloud computing system 1212 is configured to provide resources and data to client devices 1202-1208 via networks 1210. In some embodiments, cloud computing system 1200 provides resources to any number of different users (e.g., customers, tenants, organizations, etc.). Cloud computing system 1212 may be implemented by one or more computer systems (e.g., servers), virtual machines operating on a computer system, or a combination thereof.

As shown, cloud computing system 1212 includes one or more applications 1214, one or more services 1216, and one or more databases 1218. Cloud computing system 1200 may provide applications 1214, services 1216, and databases 1218 to any number of different customers in a self-service, subscription-based, elastically scalable, reliable, highly available, and secure manner.

In some embodiments, cloud computing system 1200 may be adapted to automatically provision, manage, and track a customer's subscriptions to services offered by cloud computing system 1200. Cloud computing system 1200 may provide cloud services via different deployment models. For example, cloud services may be provided under a public cloud model in which cloud computing system 1200 is owned by an organization selling cloud services and the cloud services are made available to the general public or different industry enterprises. As another example, cloud services may be provided under a private cloud model in which cloud computing system 1200 is operated solely for a single organization and may provide cloud services for one or more entities within the organization. The cloud services may also be provided under a community cloud model in which cloud computing system 1200 and the cloud services provided by cloud computing system 1200 are shared by several organizations in a related community. The cloud services may also be provided under a hybrid cloud model, which is a combination of two or more of the aforementioned different models.

In some instances, any one of applications 1214, services 1216, and databases 1218 made available to client devices 1202-1208 via networks 1210 from cloud computing system 1212 is referred to as a “cloud service.” Typically, servers and systems that make up cloud computing system 1212 are different from the on-premises servers and systems of a customer. For example, cloud computing system 1212 may host an application and a user of one of client devices 1202-1208 may order and use the application via networks 1210.

Applications 1214 may include software applications that are configured to execute on cloud computing system 1212 (e.g., a computer system or a virtual machine operating on a computer system) and be accessed, controlled, managed, etc. via client devices 1202-1208. In some embodiments, applications 1214 may include server applications and/or mid-tier applications (e.g., HTTP (hypertext transport protocol) server applications, FTP (file transfer protocol) server applications, CGI (common gateway interface) server applications, JAVA server applications, etc.). Services 1216 are software components, modules, application, etc. that are configured to execute on cloud computing system 1212 and provide functionalities to client devices 1202-1208 via networks 1210. Services 1216 may be web-based services or on-demand cloud services.

Databases 1218 are configured to store and/or manage data that is accessed by applications 1214, services 1216, and/or client devices 1202-1208. For instance, storages 125a, 130a, and/or 165-185 may be stored in databases 1218. Databases 1218 may reside on a non-transitory storage medium local to (and/or resident in) cloud computing system 1212, in a storage-area network (SAN), on a non-transitory storage medium local located remotely from cloud computing system 1212. In some embodiments, databases 1218 may include relational databases that are managed by a relational database management system (RDBMS). Databases 1218 may be a column-oriented databases, row-oriented databases, or a combination thereof. In some embodiments, some or all of databases 1218 are in-memory databases. That is, in some such embodiments, data for databases 1218 are stored and managed in memory (e.g., random access memory (RAM)).

Client devices 1202-1208 are configured to execute and operate a client application (e.g., a web browser, a proprietary client application, etc.) that communicates with applications 1214, services 1216, and/or databases 1218 via networks 1210. This way, client devices 1202-1208 may access the various functionalities provided by applications 1214, services 1216, and databases 1218 while applications 1214, services 1216, and databases 1218 are operating (e.g., hosted) on cloud computing system 1200. Client devices 1202-1208 may be computer system 1000 or computing device 1100, as described above by reference to FIGS. 10 and 11, respectively. Although system 1200 is shown with four client devices, any number of client devices may be supported.

Networks 1210 may be any type of network configured to facilitate data communications among client devices 1202-1208 and cloud computing system 1212 using any of a variety of network protocols. Networks 610 may be a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.

The above description illustrates various embodiments of the present disclosure along with examples of how aspects of the present disclosure may be implemented. The above examples and embodiments should not be deemed to be the only embodiments, and are presented to illustrate the flexibility and advantages of various embodiments of the present disclosure as defined by the following claims. Based on the above disclosure and the following claims, other arrangements, embodiments, implementations and equivalents will be evident to those skilled in the art and may be employed without departing from the spirit and scope of the present disclosure as defined by the claims.

What is claimed is:

1. A non-transitory machine-readable medium storing a program executable by at least one processing unit of a device, the program comprising sets of instructions for:
receiving a set of raw time data, each raw time data in the set of raw time data comprising an entity identifier (ID), a timestamp, and an event type;
generating a set of time events based on the set of raw time data and a time template;
generating a set of time records based on the set of time events and the time template; and
generating a set of time bundles based on the set of time records and the time template.

2. The non-transitory machine-readable medium of claim 1, wherein the time template comprises a first set of rules configured to process raw time data, a second set of rules configured to process time events, and a third set of rules configured to process time records.

3. The non-transitory machine-readable medium of claim 2, wherein generating the set of time events based on the set of raw time data comprises applying the first set of rules to the set of time events.

4. The non-transitory machine-readable medium of claim 2, wherein generating the set of time records based on the set of time events comprises applying the second set of rules to the set of time events.

5. The non-transitory machine-readable medium of claim 2, wherein generating the set of time bundles based on the set of time records comprises applying the third set of rules to the set of time records.

6. The non-transitory machine-readable medium of claim 1, wherein each time event in the set of time events comprises a timestamp from a raw time data in the set of raw time data and an event type from a raw time data in the set of raw time data.

7. The non-transitory machine-readable medium of claim 1, wherein the set of raw data is received from a time logging system.

8. A method comprising:
receiving a set of raw time data, each raw time data in the set of raw time data comprising an entity identifier (ID), a timestamp, and an event type;
generating a set of time events based on the set of raw time data and a time template;
generating a set of time records based on the set of time events and the time template; and
generating a set of time bundles based on the set of time records and the time template.

9. The method of claim 8, wherein the time template comprises a first set of rules configured to process raw time data, a second set of rules configured to process time events, and a third set of rules configured to process time records.

10. The method of claim 9, wherein generating the set of time events based on the set of raw time data comprises applying the first set of rules to the set of time events.

11. The method of claim 9, wherein generating the set of time records based on the set of time events comprises applying the second set of rules to the set of time events.

12. The method of claim 9, wherein generating the set of time bundles based on the set of time records comprises applying the third set of rules to the set of time records.

13. The method of claim 8, wherein each time event in the set of time events comprises a timestamp from a raw time data in the set of raw time data and an event type from a raw time data in the set of raw time data.

14. The method of claim 8, wherein the set of raw data is received from a time logging system.

15. A system comprising:
a set of processing units; and
a non-transitory machine-readable medium storing instructions that when executed by at least one processing unit in the set of processing units cause the at least one processing unit to:
receive a set of raw time data, each raw time data in the set of raw time data comprising an entity identifier (ID), a timestamp, and an event type;
generate a set of time events based on the set of raw time data and a time template;
generate a set of time records based on the set of time events and the time template; and
generate a set of time bundles based on the set of time records and the time template.

16. The system of claim 15, wherein the time template comprises a first set of rules configured to process raw time data, a second set of rules configured to process time events, and a third set of rules configured to process time records.

17. The system of claim 16, wherein generating the set of time events based on the set of raw time data comprises applying the first set of rules to the set of time events.

18. The system of claim 16, wherein generating the set of time records based on the set of time events comprises applying the second set of rules to the set of time events.

19. The system of claim 16, wherein generating the set of time bundles based on the set of time records comprises applying the third set of rules to the set of time records.

20. The system of claim 15, wherein each time event in the set of time events comprises a timestamp from a raw time data in the set of raw time data and an event type from a raw time data in the set of raw time data.
